(19) United States
(12) Patent Application Publication
(10) Pub. No.: US 2006/0262185 A1
(43) Pub. Date: Nov. 23, 2006

(54) Multi-channel imaging system

(75) Inventors: Kyung-hoon Cha, Yongin-si (KR); Dae-sik Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/435,931

(22) Filed: May 18, 2006

(30) Foreign Application Priority Data
May 20, 2005 (KR) 10-2005-0042462

(51) Int. Cl. H04N 13/04; H04N 5/72

(52) U.S. Cl. 348/51; 348/832

(57) ABSTRACT

Provided is a multi-channel imaging system whereby a plurality of viewers can watch a plurality of channels at the same time. The multi-channel imaging system includes an imaging unit separating images of the plurality of channels and providing the separated images to different viewing zones at the same time, and at least one directional speaker projecting sound to only one corresponding viewing zone.

### CROSS-REFERENCE TO RELATED PATENT APPLICATION

This application claims the benefit of Korean Patent Application No. 10-2005-0042462, filed on May 20, 2005, in the Korean Intellectual Property Office, the disclosure of which is incorporated herein in its entirety by reference.

### BACKGROUND OF THE INVENTION

1. Field of the Invention

The present invention relates to a multi-channel imaging system, and more particularly, to a multi-channel imaging system whereby a viewer can watch different channels at the same time.

2. Description of the Related Art

As digital signal processing technology and display technology have been developed, high resolution televisions capable of realizing stereoscopic images have been developed as well. With the development of high resolution televisions, different methods of providing three-dimensional images without the use of glasses have been suggested, and imaging systems for providing high resolution three-dimensional images are expected to be widely used in the future.

However, technology whereby viewers can watch a plurality of channels in full-size using one imaging system at the same time has not yet been developed. FIGS. 1A and 1B are plan views illustrating screens of a conventional imaging system. Referring to FIG. 1A, the conventional imaging system, such as a conventional television system, generally provides one two-dimensional image to users. That is, a main screen 100 of the conventional television system displays only an image of one channel. Referring to FIG. 1B, the conventional television system may display images of a plurality of channels, e.g., two channels by showing a second screen 110 in a corner of the main screen 100, such that an image of the second channel can be superimposed on an image of the first channel. In this case, the size of the second screen 110 is too small for users to see and comprehend easily, and the image displayed on the main screen 100 is partially covered by the second screen 110. As the size of the second screen 110 is increased to enhance the image displayed on the second screen 110, the image displayed on the main screen 100 is increasingly covered as the second screen 110 increases, thereby making it difficult to see the image on the main screen 100.

Because of these problems, television systems installed in public places, such as stations, terminals, or banks, can provide an image from only one channel. Accordingly, in order to satisfy diverse tastes of people who frequent public places, a plurality of television systems should be installed to provide images from a plurality of channels.

### SUMMARY OF THE INVENTION

The present invention provides a multi-channel imaging system whereby a plurality of viewers can see full-size images of different channels at the same time.

According to an aspect of the present invention, there is provided a multi-channel imaging system comprising: an imaging unit separating images on a plurality of channels and providing the separated images to different viewing zones at the same time; and at least one directional speaker projecting sound to corresponding viewing zones, whereby each directional speaker projects sound to only its corresponding viewing zone.

The imaging unit may comprise: a display panel alternately displaying the images from the plurality of channels pixel by pixel horizontally or vertically; and a multi-channel screen disposed in front of the display panel and adapted to separate the images of the plurality of channels alternately displayed pixel by pixel on the display panel and transmit the separated images to different viewing zones. The multi-channel screen may be one of a parallax barrier and a lenticular lens.

The multi-channel imaging system may further comprise a directional remote controller changing only a channel in a specific viewing zone. The multi-channel imaging system may further comprise a sensor detecting a position of the directional remote controller relative to the imaging unit based on an area from which a signal generated by the directional remote controller is received.

The images provided to the different viewing zones may have the same size.

The images of the plurality of channels may comprise images provided from a television, a computer monitor, a video cassette recorder (VCR), a camcorder, and a digital versatile disk (DVD).

The multi-channel imaging system may operate in one of a stereoscopic image mode and a multi-channel image mode according to a user's selection. In the stereoscopic image mode, the display panel may alternately display an image for a left eye and an image for a right eye pixel by pixel, horizontally or vertically.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B are plan views illustrating screens of a conventional imaging system;

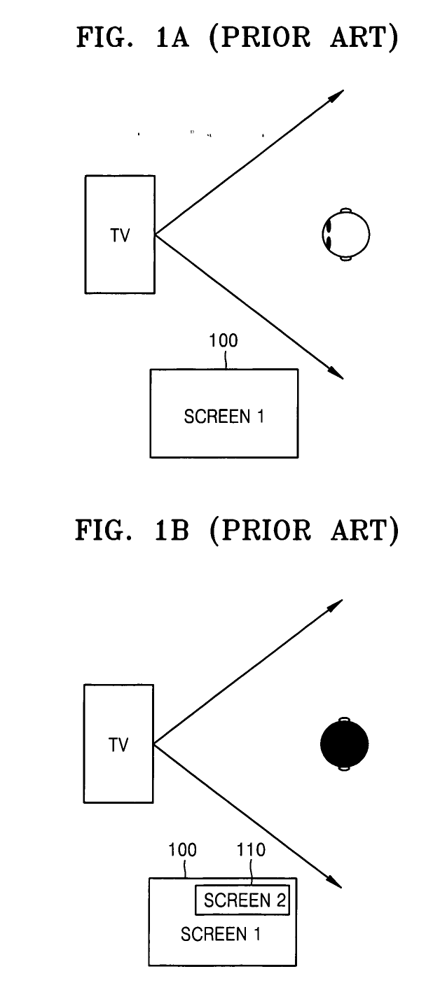

FIGS. 2A and 2B are views for explaining the principle of a three-dimensional image display, on which a multi-channel imaging system according to the present invention is also based;

FIGS. 3A through 3C illustrate various operating modes of the multi-channel imaging system according to the present invention;

FIG. 4 schematically shows a structure of a multi-channel imaging system according to an embodiment of the present invention;

FIG. 5 is a block diagram of an imaging unit of the multi-channel imaging system of FIG. 4;

FIG. 6A schematically shows a structure of a multi-channel imaging system according to another embodiment of the present invention; and

FIG. 6B is a view illustrating arrangement of images displayed on a display unit of the imaging system of FIG. 6A.

### DETAILED DESCRIPTION OF THE INVENTION

The present invention will now be described more fully with reference to the accompanying drawings, in which exemplary embodiments of the invention are shown.

A multi-channel imaging system according to the present invention adopts a principle of viewing zone separation on which stereoscopic image displays are based. That is, the multi-channel imaging system according to the present invention uses a principle of a glassesless stereoscopic image display system that separates left eye images from right eye images to obtain a three-dimensional image without the use of polarization glasses. Glassesless stereoscopic image displays are generally divided into parallax barrier displays and lenticular displays. Other various technologies have been developed to realize stereoscopic images.

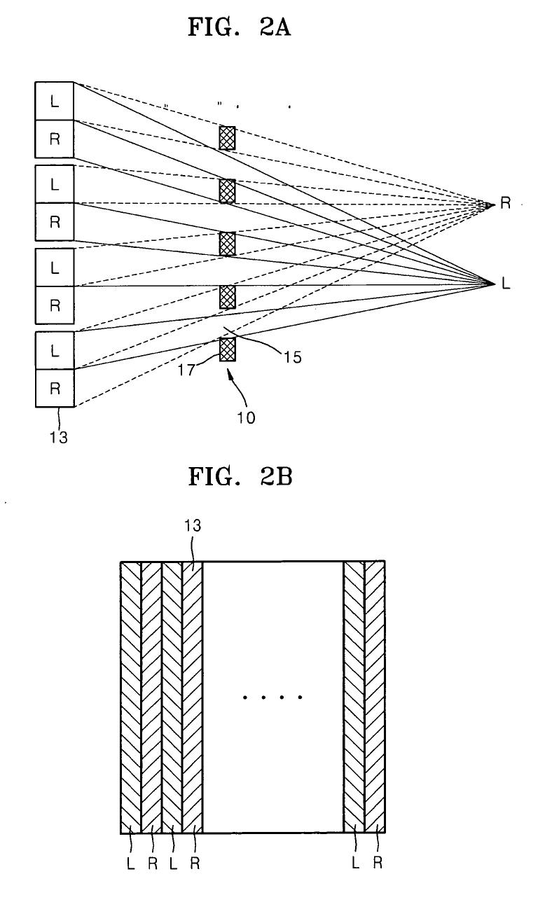

In a parallax barrier display, images to be viewed by left and right eyes are displayed in an alternate vertical pattern. Vertical pattern images to be viewed by the left eye and vertical pattern images to be viewed by the right eye are separated by a very thin vertical lattice, that is, a barrier, and the left and right eyes see images at different viewpoints, thereby seeing a three-dimensional image. FIGS. 2A and 2B are views for explaining the principle of the parallax barrier three-dimensional image display. Referring to FIG. 2A, a parallax barrier 10 having apertures 15 and masks 17 formed in a vertical grating pattern is disposed in front of a display panel 13 that displays left-eye images L and right-eye images R respectively corresponding to a viewer's left eye and right eye. Referring to FIG. 2B, the display panel 13 alternately displays the left-eye images L and the right-eye images R in a vertical grating pattern horizontally. Here, a width of each vertical grating pattern of the left-eye images L and the right-eye images R may correspond to a width of one pixel. Then, the left-eye images L and the right-eye images R are separated by the apertures 15 of the parallax barrier 10 such that each eye sees a different image. As a result, the viewer can see a stereoscopic image without polarization glasses.

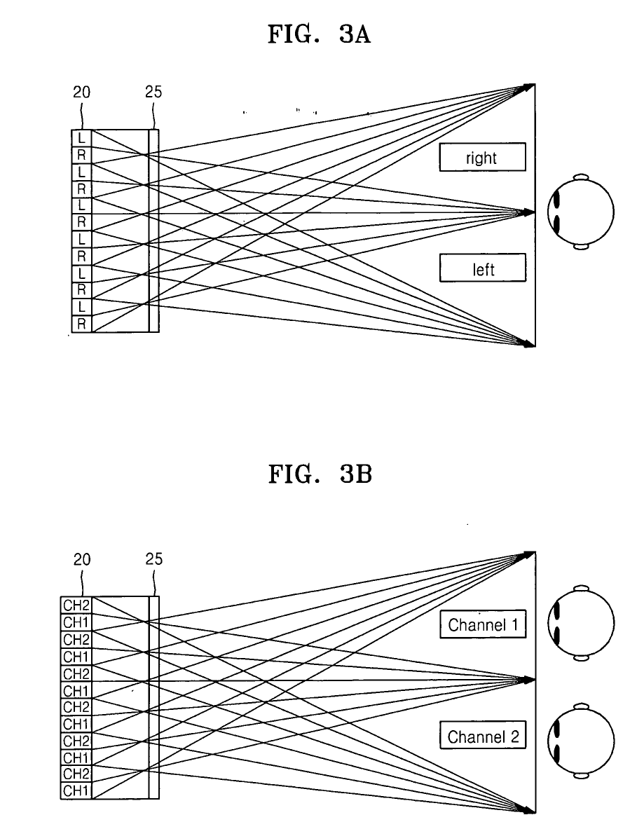

The multi-channel imaging system according to the present invention displays an image from a first channel and an image from a second channel, instead of an image for a left eye and an image for a right eye displayed by the stereoscopic image display. FIGS. 3A through 3C illustrate various operating modes of the multi-channel imaging system according to the present invention.

Since the multi-channel imaging system according to the present invention is based on the same principle as that used by the glassesless stereoscopic image display, the multi-channel imaging system can provide a three-dimensional image as shown in FIG. 3A. In detail, a display panel 20 alternately displays a left-eye image L and a right-eye image R in a vertical grating pattern horizontally pixel by pixel, and a multi-channel screen 25 disposed in front of the display panel 20 separates the left-eye image L and the right-eye image R. Then, a viewer's left eye and right eye separately view the left-eye image L and the right-eye image R to see a three-dimensional image. The multi-channel screen 25 may be a parallax barrier or a lenticular lens, or may be configured using another three-dimensional image technology. The display panel 20 may be a direct-view display, e.g., a liquid crystal display (LCD) panel, a plasma display panel, and an organic electro-luminescence (EL) display, or a projection type display.

FIG. 3B illustrates a mode in which two-dimensional images of a plurality of channels are simultaneously provided according to the present invention. Referring to FIG. 3B, the display panel 20 alternately displays an image CH1 of a first channel and an image CH2 of a second channel in a vertical grating pattern horizontally pixel by pixel, and the multi-channel screen 25 separates the image CH1 of the first channel and the image CH2 of the second channel and provides the separated images CH1 and CH2 to different viewing zones. Then, a viewer present in a first viewing zone can see a full-size two-dimensional image from the first channel, and a viewer present in a second viewing zone can see a full-size two-dimensional image from the second channel.

FIG. 3C illustrates a mode in which a navigation image and a television image are simultaneously provided based on the same principle as described with reference to FIGS. 3A and 3B. Referring to FIG. 3C, the display panel 20 alternately displays a television image TV and a navigation image NV in a vertical grating pattern horizontally pixel by pixel, and the multi-channel screen 25 separates the television image TV and the navigation image NV and provides the separated images TV and NV to different viewing zones. Then, a viewer present in a first viewing zone can see the television image TV and a viewer present in a second viewing zone can see the navigation image NV. If the multi-channel imaging system according to the present invention is mounted in a vehicle, a driver can see navigation information and a person in a seat next to the driver can watch television.

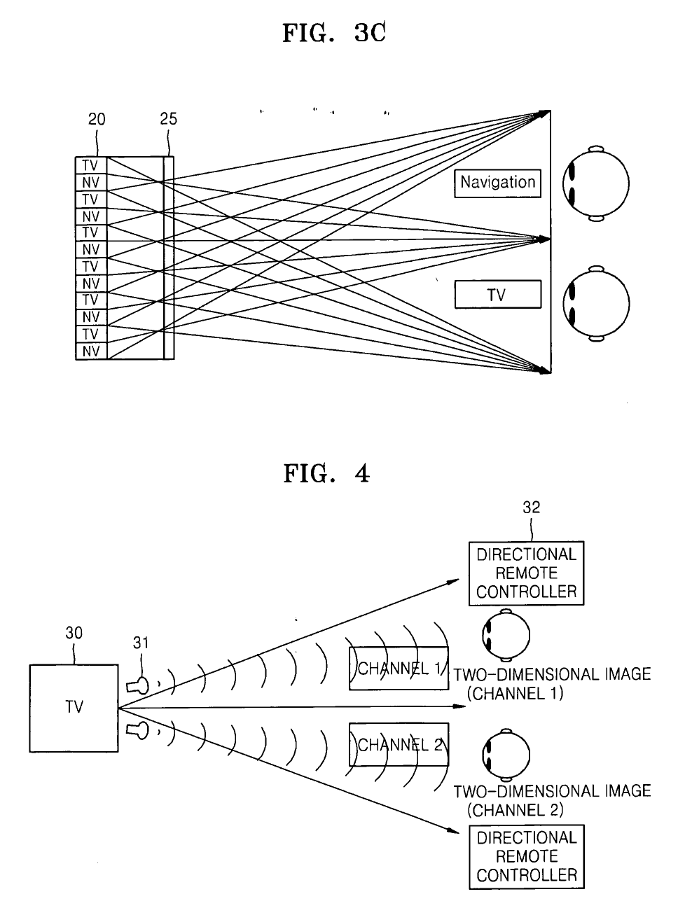

FIG. 4 schematically shows a structure of a multi-channel imaging system according to an embodiment of the present invention. Referring to FIG. 4, an imaging unit 30 separates images of a plurality of channels and provides the separated images to different viewing zones. That is, as shown in FIGS. 3A through 3C, the imaging unit 30 includes the display panel 20 and the multi-channel screen 25. Referring to FIG. 4, when the imaging unit 30 separates images of two channels and provides the separated images to different viewing zones, a viewer present at the right side of the imaging unit 30 can see a full-size image from the first channel, and a viewer present at the left side of the imaging unit 30 can see a full-size image from the second channel.

A directional speaker 31 may be used to project sound corresponding to a channel into a pertinent viewing zone. The directional speaker 31 projects sound into a very narrow space to be audible only in a specific area, not to be audible in other areas. When a plurality of directional speakers 31 are used corresponding to the plurality of channels, a viewer looking at an image from the first channel in the first viewing zone can hear only the sound corresponding to the first channel but cannot hear the sound corresponding to the second channel. Also, a viewer looking at an image from the second channel in the second viewing zone can hear only the sound corresponding to the second channel but cannot hear the sound corresponding to the first channel. Since the viewers can hear only the sound corresponding to the images from the channels that they are viewing, they can look at the images at ease.

A directional remote controller 32 may also be used to enhance user convenience. The directional remote controller 32 is designed to transmit infrared rays or a high frequency signal only into a very narrow space according to a user's operation. Since the signal of the directional remote controller 32 does not propagate into a large space, the imaging unit 30 can detect the exact position of the remote controller 32 based on the signal received from the remote controller 32. Accordingly, when a user present in a specific viewing zone operates the directional remote controller 32, only the channel in the specific viewing zone is changed while channels in other viewing zones are unchanged.

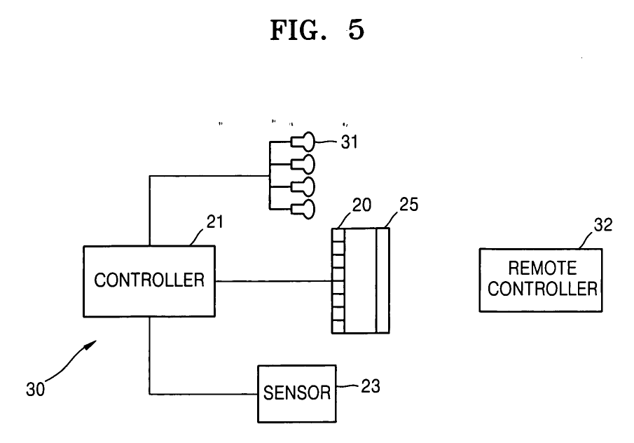

FIG. 5 is a block diagram of the imaging unit 30. Referring to FIG. 5, the imaging unit 30 includes a sensor 23 receiving a signal from the directional remote controller 32 and detecting the position of the directional remote controller 32, and a controller 21 controlling the display panel 20 and the directional speaker 31 according to a user's command. In a three-dimensional image mode, the controller 21 synthesizes a left-eye image signal and a right-eye image signal and transmits the synthesized signals to the display panel 20. In a multi-channel mode, the controller 21 synthesizes signals from a plurality of channels and transmits the synthesized signals to the display panel 20. The controller 21 controls sound signals from different channels to be provided to corresponding directional speakers 31 according to the positions of the directional speakers 31. When receiving a signal indicating a change of a channel in the multi-channel mode, the sensor 23 detects the position of the remote controller 32 relative to the imaging unit 30 based on where the signal is received from, and transmits information on the detected position of the remote controller 32 to the controller 21. Thereafter, the controller 21 calculates a viewing zone in which the remote controller 32 is now positioned from the position information received from the sensor 23, and changes only the channel in the calculated viewing zone.

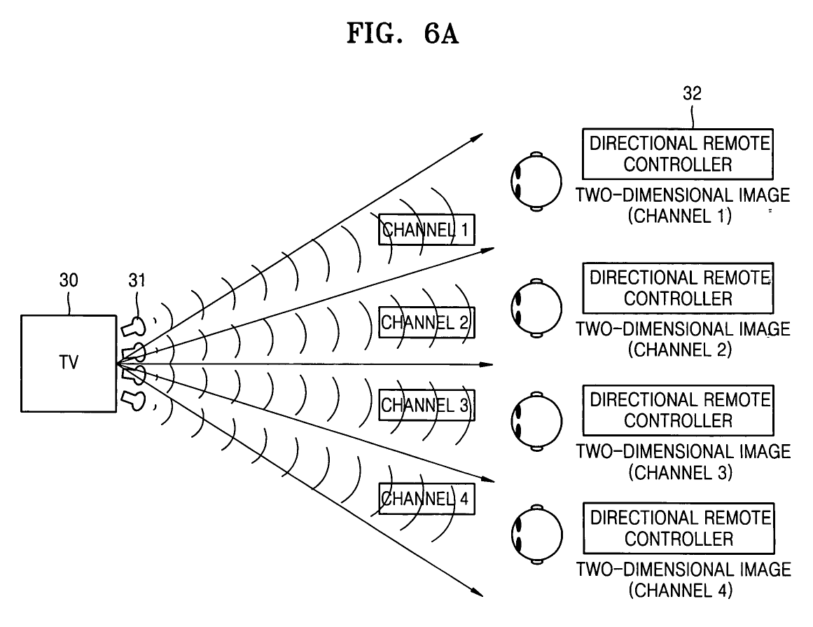

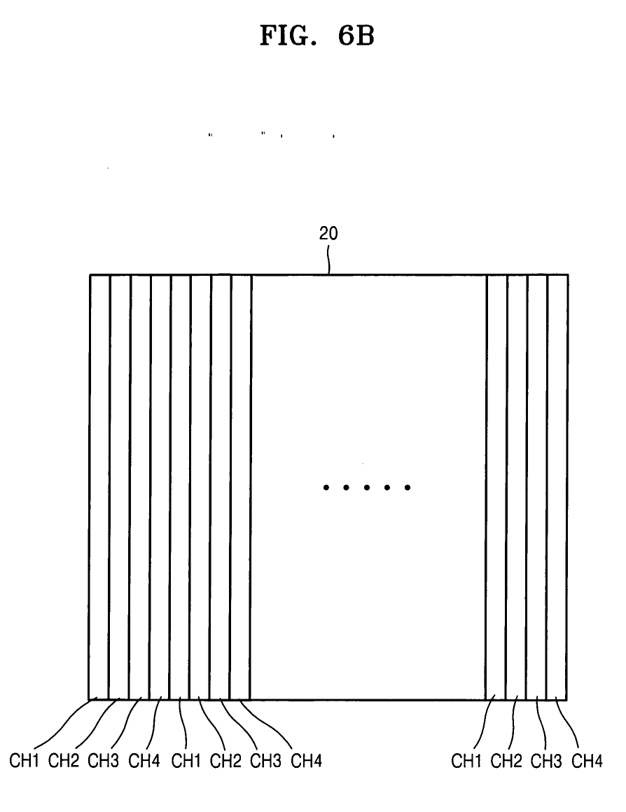

Although the multi-channel imaging system shown in FIG. 4 separates images of channels and simultaneously displays the separated images in two different viewing zones, the multi-channel imaging system can separate and display images of two or more channels. FIG. 6A schematically shows such a multi-channel imaging system. For example, when there are four channels, a viewing angle is divided into four zones such that images of the four channels can be seen in four viewing zones. For instance, referring to FIG. 6B, the display panel 20 alternately displays images CH1 through CH4 of first through fourth channels in a vertical grating pattern, and the multi-channel screen 25 separates the images CH1 through CH4 of the first through fourth channels and provides the separated images CH1 through CH4 to the four viewing zones.

When the display panel 20 alternately displays images from a plurality of channels in a vertical grating pattern horizontally pixel by pixel, a plurality of viewing zones are formed to be of the same height and at an azimuth angle. However, when the display panel 20 alternately displays images from a plurality of channels in a horizontal grating pattern vertically pixel by pixel, a plurality of viewing zones may have different heights. In this case, viewers present at different heights can see images of different channels.

As described above, the multi-channel imaging system according to the present invention allows a plurality of viewers to see full-size two-dimensional images from different channels at the same time. Accordingly, when the multi-channel imaging system is installed in public places, such as stations, terminals, or banks, a plurality of viewers can satisfy their viewing tastes using only one imaging system. Furthermore, when the multi-channel imaging system is used together with an image signal source, such as, for example, a television, a navigator, a computer monitor, a video cassette recorder (VCR), a camcorder, or a digital versatile disk (DVD), images from various devices can be simultaneously provided using only one imaging system.

Moreover, since the multi-channel imaging system is based on the principle of the three-dimensional image display, the multi-channel imaging system can realize a three-dimensional image if required.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A multi-channel imaging system comprising:
an imaging unit, separating images of a plurality of channels and providing the separated images to different viewing zones at the same time; and
at least one directional speaker projecting sound to corresponding viewing zones, whereby an induced directional speaker projects sound to only its corresponding viewing zone.

2. The multi-channel imaging system of claim 1, wherein the imaging unit comprises:
a display panel alternately displaying the images of the plurality of channels pixel by pixel horizontally or vertically; and
a multi-channel screen disposed in front of the display panel and adapted to separate the images of the plurality of channels alternately displayed pixel by pixel on the display panel and transmit the separated images to different viewing zones.

3. The multi-channel imaging system of claim 2, wherein the multi-channel screen is one of a parallax barrier and a lenticular lens.

4. The multi-channel imaging system of claim 2, further comprising a directional remote controller changing only a channel in a specific viewing zone.

5. The multi-channel imaging system of claim 4, further comprising a sensor detecting a position of the directional remote controller relative to the imaging unit based on an area from which a signal generated by the directional remote controller is received.

6. The multi-channel imaging system of claim 2, wherein the images provided to the different viewing zones have the same size.

7. The multi-channel imaging system of claim 2, wherein the images of the plurality of channels comprise images provided from at least one of a television, a computer monitor, a video cassette recorder (VCR), a camcorder, and a digital versatile disk (DVD).

8. The multi-channel imaging system of claim 2, operating in one of a stereoscopic image mode and a multi-channel image mode according to a user's selection.

9. The multi-channel imaging system of claim 8, wherein, in the stereoscopic image mode, the display panel alternately displays an image for a left eye and an image for a right eye pixel by pixel, horizontally or vertically.

10. A multi-channel imaging system comprising:
an imaging unit separating images of a plurality of channels and providing the separated images to different viewing zones at the same time.

11. The multi-channel imaging system of claim 10, wherein the imaging unit comprises:
a display panel alternately displaying the images of the plurality of channels pixel by pixel horizontally or vertically; and
a multi-channel screen disposed in front of the display panel and adapted to separate the images of the plurality of channels alternately displayed pixel by pixel on the display panel and transmit the separated images to different viewing zones.

12. The multi-channel imaging system of claim 11, wherein the multi-channel screen is one of a parallax barrier and a lenticular lens.

13. The multi-channel imaging system of claim 11, further comprising a directional remote controller changing only a channel in a specific viewing zone.

14. The multi-channel imaging system of claim 13, further comprising a sensor detecting a position of the directional remote controller relative to the imaging unit based on an area from which a signal generated by the directional remote controller is received.

15. The multi-channel imaging system of claim 11, wherein the images provided to the different viewing zones have the same size.

16. The multi-channel imaging system of claim 11, wherein the images of the plurality of channels comprise images provided from at least one of a television, a computer monitor, a video cassette recorder (VCR), a camcorder, and a digital versatile disk (DVD).

17. The multi-channel imaging system of claim 11, operating in one of a stereoscopic image mode and a multi-channel image mode according to a user's selection.

18. The multi-channel imaging system of claim 17, wherein, in the stereoscopic image mode, the display panel alternately displays an image for a left eye and an image for a right eye pixel by pixel, horizontally or vertically.
